(19) United States
(12) Patent Application Publication
(10) Pub. No.: US 2023/0132172 A1
(43) Pub. Date: Apr. 27, 2023

(54) Reversible Caulk Dispenser

(71) Applicant: Oak Enterprises, LLC, Oklahoma City, OK (US)

(72) Inventor: Dale Tomazin, Gainesville, GA (US)

(73) Assignee: Oak Enterprises, LLC, Oklahoma City, OK (US)

(21) Appl. No.: 17/970,157

(22) Filed: Oct. 20, 2022

Related U.S. Application Data
(60) Provisional application No. 63/270,145, filed on Oct. 21, 2021.

(51) Int. Cl. B05C 17/005; B05C 17/01

(52) U.S. Cl. CPC B05C 17/00576; B05C 17/00506; B05C 17/0116

(57) ABSTRACT

A reversible and reusable caulk dispenser for use with a caulk gun. The caulk dispenser has a tubular cartridge with a plunger inside the cartridge near a first open end of the cartridge and an end cap with a nozzle that can be attached at an open second end of the cartridge. A foil packet of caulk or sealant material is inserted in the cartridge of the dispenser. A closed end of the packet is positioned adjacent the plunger while an open end of the packet is at the end of the cartridge where the end cap is attached. The dispenser is used in a standard caulk gun and the caulk material expelled through the nozzle as the caulk gun is operated. When the packet is emptied the dispenser can be reused with a new packet inserted and the end cap attached now to the opposite end of the cartridge.

### CROSS REFERENCE TO RELATED APPLICATIONS

The present claims benefit of U.S. Provisional Application 63/270,145, filed on Oct. 21, 2021, which is hereby incorporated by reference in its entirety.

### FIELD OF THE INVENTION

The disclosed system relates to tools for caulking or the like, and in particular to caulk tubes for use with caulk guns.

### SUMMARY OF THE INVENTION

The present invention is directed to a reversible and reusable caulk dispenser. The caulk dispenser comprises a tubular cartridge defining an internal chamber, a cylindrical plunger disposed within the internal chamber and concentric with the cartridge, and an end cap. The cartridge comprises an open first end and an open second end. The plunger is disposed within the internal chamber and concentric with the cartridge and comprises a circumferential outer wall, a circular center plate disposed within the cylindrical outer wall and perpendicular to the outer wall, a first inner wall, and a second inner wall. The outer wall has a first end and a second end. The center plate has a first planar side and a second planar side, and the center plate may define an air flow port at a center of the center plate with the air flow port connecting the first planar side and the second planar side. The first inner wall descends from the first end of the outer wall to the first planar side of the center plate, and the first inner wall may be tapered from the outer wall towards the center of the center plate. The second inner wall descends from the second end of the outer wall to the second planar side of the center plate, and the second inner wall may be tapered from the outer wall to the center of the center plate. The end cap comprises a circular planar cap face having a top side and a bottom side, an outer ring extending from the bottom side of the cap face, an inner ring extending from the bottom side of the cap face, and a nozzle extending from the top side of the cap face. The cap face defines a discharge port at a center of the cap face. The outer ring is cylindrical and concentric with the cap face and the inner ring is cylindrical and concentric with the cap face. The nozzle is cylindrical in nature and defines a flow path through the discharge port of the cap face. The outer ring is disposed proximate a perimeter of the cap face and the inner ring is disposed proximate a perimeter of the port of the cap face. The end cap is adapted to be removably attached to the first end or the second end of the cartridge.

In an alternative embodiment the invention is directed to a reusable and reversible caulk dispenser. The dispenser comprises a tubular cartridge defining an internal chamber, a cylindrical plunger disposed within the internal chamber and concentric with the cartridge, and an end cap. The cartridge comprises an open first end and an open second end. The end cap comprises a circular planar cap face having a top side and a bottom side, an outer ring extending from the bottom side of the cap face, an inner ring extending from the bottom side of the cap face, and a nozzle extending from the top side of the cap face. The cap face defines a discharge port at a center of the cap face. The outer ring is cylindrical and concentric with the cap face and the inner ring is cylindrical and concentric with the cap face. The nozzle is cylindrical in nature and defines a flow path through the discharge port of the cap face. The outer ring is disposed proximate a perimeter of the cap face and the inner ring is disposed proximate a perimeter of the port of the cap face. The end cap is adapted to be removably attached to the first end or the second end of the cartridge.

In yet another embodiment the invention is directed to a method for using a caulk dispensing the system. The method comprises the step of inserting a packet of material in a tubular cartridge of a reusable caulk dispenser, the cartridge having an open first end and an open second end. The packet of material is positioned such that a closed end of the packet is adjacent a plunger disposed in the cartridge and such that an open end of the packet is proximate the first end of the cartridge. The method comprises the steps of attaching an end cap comprising a nozzle to the first end of the cartridge, placing the caulk dispenser in a caulk gun, and operating the caulk gun to advance the plunger in the cartridge and thereby expel material from the caulk dispenser through the nozzle of the end cap such that the packet is compressed around an inner ring of the end cap. The method comprises removing the caulk dispenser from the caulk gun, removing the end cap from the first end of the caulk dispenser and removing the packet of material from the around the inner ring of the end cap of the caulk dispenser. The method also comprises the step of inserting a new packet of material in the second end of the cartridge of the caulk dispenser, such that a closed end of the new packet is adjacent the plunger and such that an open end of the new packet is proximate the second end of the cartridge. The method further comprises the steps of attaching the end cap to the second end of the cartridge and placing the caulk dispenser in the caulk gun.

### BRIEF DESCRIPTION OF THE DRAWINGS

FIG. 1 is an elevation view of a reversible caulk dispenser in accordance with the present invention.

FIG. 2 is a plan view of the assembled caulk tube.

FIG. 3 is a cross-sectional view of a plunger for the caulk tube of FIG. 2.

FIG. 4 is an isometric view of an end cap for the caulk tube of FIG. 2.

FIG. 5 is another isometric view of an end cap for the caulk tube of FIG. 2.

FIG. 6 is a plan view the caulk dispenser of FIG. 1 after expelling caulk from the caulk dispenser.

FIG. 7 is a plan view the caulk dispenser of FIG. 6 after further expelling caulk from the caulk dispenser.

FIG. 8 is a view of the caulk tube removed from the caulk dispenser and having an empty caulk packet.

### DETAILED DESCRIPTION

Caulks and sealants of various types are regularly used for filling cracks or gaps in homes, buildings, and concrete or for bonding building materials. Caulks and sealants usually come in a tube that may be made of plastic or a cardboard material. A caulk gun is a handheld tool used to dispense the caulk or sealant from the tube. When the tube is empty, the tube is removed from the caulk gun and generally disposed of. Current procedures generate significant caulk and packaging material waste. The present invention contemplates a reusable caulk dispenser that significantly limits waste to a substantially empty foil pack of caulk or sealant material.

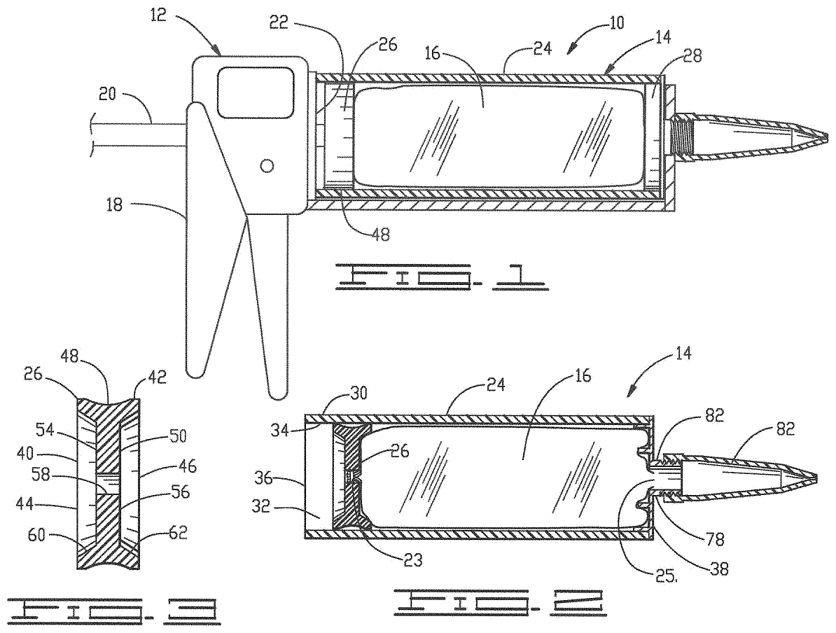

Turning now to the drawings and FIG. 1 in particular, there is shown therein a dispensing system 10 for dispensing caulk, liquid sealant, or other matter. The dispensing system 10 comprises a representative caulk gun 12, a reusable and reversible dispenser 14 built in accordance with the present invention, and a disposable packet 16 containing caulk, sealant, or other liquid matter. The caulk gun 12 generally comprises a trigger assembly 18, a piston rod 20 operatively attached to the trigger assembly, and a cartridge receptacle 22. The reusable and reversible dispenser 14 is operatively disposed within the cartridge receptacle 22 of the caulk gun 12. As one skilled in the art will understand, the caulk gun 12 may be operated to expel caulk or other material from the disposable packet 16.

The packet 16 is preferably adapted to hold or store a volume of caulk or sealant or other desired liquid material. Preferably, the packet 16 is made of foil or other pliable material. More preferably the packet 16 would hold approximately 10 ounces of material as would a standard caulk tube. The packet 16 may further comprise metal sealing clips 23 (shown in FIG. 2) for closing the packet until the packet is to be used. As one skilled in the art will appreciate use of the packet 16 requires for one sealing clip 23 to be cut off of the packet to allow an open end 25 of the packet for dispensing of the caulk or other material contained in the packet.

With additional reference now to FIG. 2, the reusable and reversible dispenser 14 is shown and discussed in greater detail. The dispenser 14 comprises a cartridge 24, a plunger 26, and an end cap 28. The cartridge 24 comprises a reusable sleeve or tube 30 that is a tubular member defining an open interior chamber 32 having a circumferential internal wall 34. The reusable tube 30 comprises an open first end 36 and an open second end 38. Preferably, the reusable tube 30 is made of plastic. More preferably the reusable tube 30 will approximate or match the size of a conventional 10 ounce caulk tube as known and used in the art. Most preferably the tube 30 will comprise a transparent or semi-transparent plastic or like material. The transparent nature of the tube permits visual inspection of the contents, namely the packet 16 and the position of the plunger 26 along a length of the tube 30.

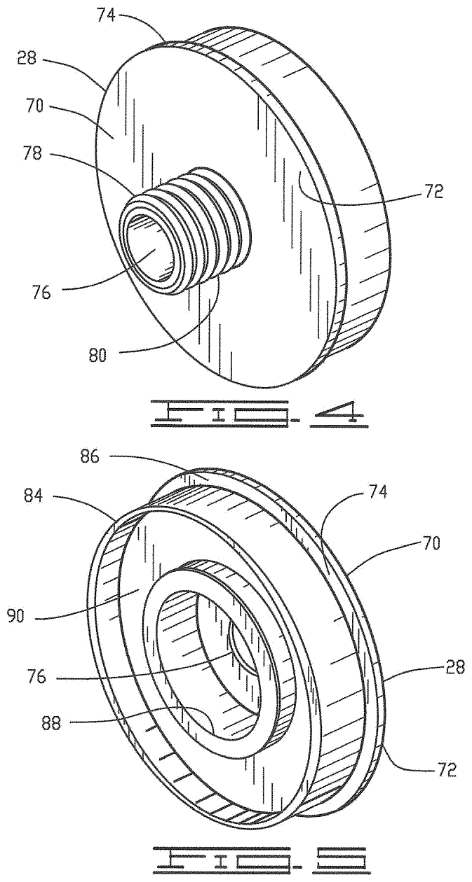

Shown in greater detail in FIG. 3, the plunger 26 preferably comprises a solid cylindrical member 40 having a circumferential outer wall 42 and is sized to fit within the reusable tube 30. The plunger 26 is preferably concentrically positioned in the reusable tube 24 such that the circumferential outer wall 42 of the plunger is in contact with the internal wall 34 of the reusable tube. Preferably, the plunger 26 may be moved bidirectionally along a length of the interior chamber 22 of the reusable cartridge 24. The outer wall 42 of the plunger 26 has a first end 44 and a second end 46. The plunger 26 has a first base at the first end 44 or the outer wall 42 and a second base at the second end 46 of the outer wall. Preferably, the first base and the second base are parallel to each other. More preferably, an external surface 48 of the outer wall 42 is flat as with a right cylinder (shown in FIG. 1), and thus with the external surface in full contact with the reusable cartridge 24. The right cylinder construction of the external surface 48 of the outer wall 42 creates a friction with the internal wall 34 of the cartridge 24 and provides and increased stability for the dispenser 14. Alternatively, and as shown in FIG. 3 (and FIGS. 2, 6-8), the external surface 48 of the outer wall 42 may be concave in nature. The concave nature of the external surface 48 allows for less friction with the wall 34 of the cartridge 24.

Continuing with FIG. 3, the plunger 26 comprises a circular center plate 50 disposed within the cylindrical outer wall 42 and perpendicular to the outer wall. The center plate 50 comprises a first planar side 52 opposing the first base and the first end 44 of the outer wall 42 and a second planar side 54 opposing the second base and second end 46 of the outer wall. Additionally, the center plate 50 defines an air flow port 58 at a center of the center plate, the air flow port connecting the first planar side 52 and the second planar side 54 of the center plate. The air flow port 52 prevents a vacuum from being created in the tube 30 by allowing for better flow of air on both side of the plunger 26. Additionally, the air flow port 52 provides a relief area for the sealing clip 23 of the packet 16 (as shown in FIG. 2) which in turn facilitates maximizing space within the tube 30 and emptying of the packet during use of the dispenser 14.

The plunger 26 further comprises a first inner wall 60 and a second inner wall 62. The first inner wall 60 descends from the first base and the first end 44 of the outer wall 42 to the first planar side 54 of the center plate 50. The second inner wall 62 descends from the second base and the second end 46 of the outer wall 42 to the second planar side 56 of the center plate 50. Preferably, the first inner wall 60 and the second inner wall 62 are tapered from proximate the ends 44 and 46 of the outer wall 42 toward the center of the center plate 50. One skilled in the art will appreciate the recesses created by the tapered nature of the walls 60 and 62 and the plate 50 allows the plunger 26 to operatively receive a disc (not shown) on the end of the piston rod 20 in a flush manner. Additionally, the recesses created by the tapered nature of the walls 60 and 62 and the plate 50 allows the plunger 26 to operatively and optimally receive the packet 16 of caulk.

Preferably the plunger 26 is made of aluminum but may be formed of plastic or other suitable material. More preferably, the plunger 26 dimensions will be such that the outer wall 42 is approximately ½″ in length and the center plate 50 is approximately 1/10″ in thickness. These dimensions allow for optimal travel of the plunger 26 along the interior 34 of the tube 24.

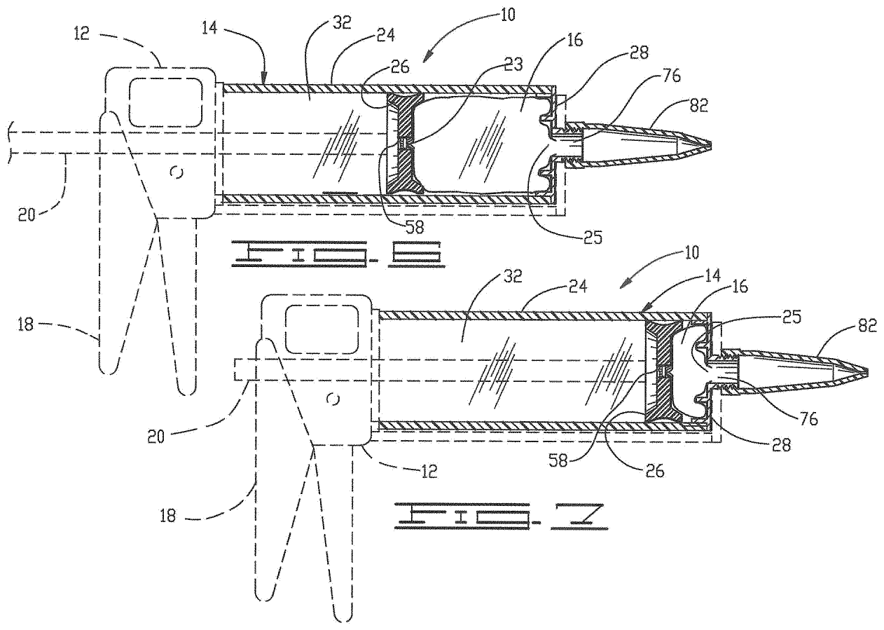

Turning now to FIGS. 4 and 5, the end cap 28 of the reversible dispenser 14 is shown and discussed in greater detail. The end cap 28 comprises a circular planar cap face 70 having a top side 72 and a bottom side 74. The cap face 70 defines a discharge port 76 at a center of the cap face. Preferably the discharge port 76 is circular in nature. The end cap 28 further comprises a nozzle 76 extending form the top side 72 of the cap face 70. Preferably the nozzle 78 is a hollow cylinder in shape and positioned to define a flow path through the discharge port 76. More preferably, an exterior surface 80 of the nozzle 76 may be threaded to receive a nozzle attachment 82 (shown in FIG. 2). The removable nature of the nozzle attachment 82 allows for flexibility and reusability for the dispenser 14. Alternatives to the threaded nature of the nozzle 78 and the nozzle attachment 82 are contemplated as desired.

Continuing with FIG. 5, the end cap 28 further comprises an outer ring 84 extending from the bottom side 74 of the cap face 72. The outer ring 84 is cylindrical and concentric with the cap face 72. Preferably the outer ring 84 has an outer diameter that approximates an inner diameter of the reusable tube 30. More preferably, the outer ring 84 is disposed slightly inside of a circumference of the cap face 72. The position of the outer ring 84 defines a cap lip 86, a surface of the cap face 72 that extends from the outer ring 84. One skilled in the art will appreciate the position of the outer ring 84 and the cap lip 84 permits the end cap 28 to be inserted and set into either the first end 36 or the second end 38 of the reversible tube 30. In this manner the end cap 28 is adapted to be removably attached to the first end 36 or the second end 38 of the cartridge 24. Alternatively, the outer ring 84 of the end cap 28 could be sized such that an inner diameter of the outer ring approximates an outer diameter of the tube 30. In this arrangement the end cap 28 would be removably attached to the tube 30 by the outer ring 84 being slid over the first end 36 or the second end 38 of the tube 30.

The end cap 28 further comprises an inner ring 88 extending from the bottom side 74 of the cap face 70. The inner ring 88 is cylindrical and concentric with the cap face 72. The inner ring 88 is disposed proximate a perimeter of the port 76 of the cap face 72. The position of the inner ring 88 relative to the outer ring 84 defines a receiving area 90 between the inner ring and the outer ring, the purposes of which are yet to be described.

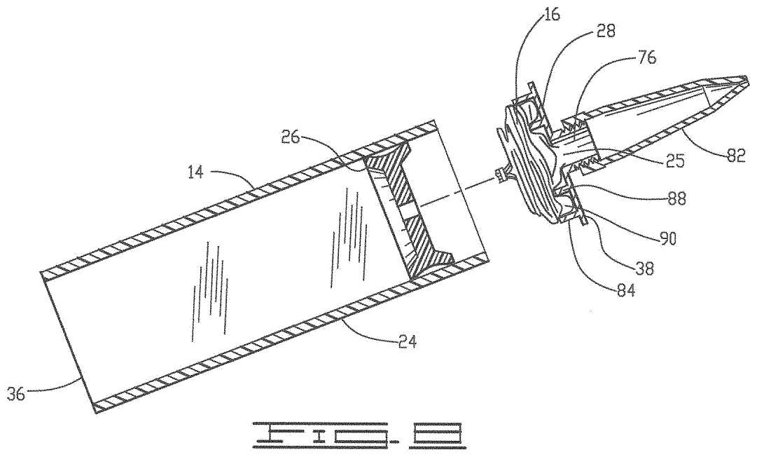

Referring now to FIGS. 6 and 7, the caulk dispensing system 10 in states where the caulk gun 12 has been operated such that material (not shown) has been expelled from the packet 16. As illustrated, the reversible dispenser 14 is positioned in the cartridge receptacle 22 of the caulk gun 12. Operation of the gun 12 advances the piston 20 against the plunger 26 within the reusable tube 30. Movement of the plunger 26 compresses the packet 16 of caulk, shown with the sealing clip 23 of the packet nestled in the port 58 of the plunger 26. Compression of the packet 16 causes material in the packet to be expelled through the open end 25 the packet and through the nozzle 76.

Turning now to FIG. 8, the dispenser 14 is shown removed from the caulk gun 12 with the packet 16 empty, with substantially all caulk material expelled from the packet, as a result of the operation of the caulk gun as discussed above. The substantially empty packet 16 is now significantly compressed around the inner ring 88 of the end cap 28 and in the receiving area 90 between the inner ring and the outer ring 84. At this point in the operation of the dispenser 14, the end cap 28 is removed from the second end 38 of the tube 24 so that the used and empty packet 16 can also be removed and then discarded. Notably, the plunger 26 is now proximate the second end 38 of the cartridge 24, having been advanced to that position during operation of the caulk gun 12. Now a new and full packet 16 of caulk material is inserted into the open first end 36 of the cartridge 24 such that a sealing clip 23 at a closed end of the new packet is adjacent the first end 44 of the plunger 26 and such that an open end 25 of the new packet is proximate the first end of the cartridge. The end cap 28 then secured to the first end 36 of the cartridge 24. The caulk dispenser 14 can then be positioned in the cartridge receptacle 22 of the caulk gun 12 and ready for further use. One skilled in the art will appreciate the

Various modifications can be made in the design and production of the present invention without departing from the spirit thereof. Thus, while the principal preferred construction and use of the invention have been explained in what is now considered to represent its best embodiments, it should be understood that the invention may be practiced otherwise than as specifically illustrated and described, and claimed in the following claims.

What is claimed is:

1. A reusable and reversible caulk dispenser comprising:
a tubular cartridge defining an internal chamber, the cartridge comprising an open first end and an open second end;
a cylindrical plunger disposed within the internal chamber and concentric with the cartridge, the plunger comprising:
a circumferential outer wall having a first end and a second end;
a circular center plate disposed within the cylindrical outer wall, the center plate having a first planar side and a second planar side;
a first inner wall, the first inner wall tapering from the first end of the outer wall to the first planar side of the center plate; and
a second inner wall, the second inner wall tapering from the second end of the outer wall to the second planar side of the center plate; and
an end cap comprising:
a circular planar cap face having a top side and a bottom side, the cap face defining a discharge port at a center of the cap face;
an outer ring extending from the bottom side of the cap face, the outer ring being cylindrical and concentric with the cap face;
an inner ring extending from the bottom side of the cap face, the inner ring being cylindrical and concentric with the cap face; and
a nozzle extending from the top side of the cap face, the nozzle being cylindrical in nature and defining a flow path through the discharge port of the cap face;
wherein the outer ring is disposed proximate a perimeter of the cap face and the inner ring is disposed proximate a perimeter of the discharge port of the cap face;
wherein the end cap is adapted to be removably attached to the first end or the second end of the cartridge.

2. The dispenser of claim 1 further comprising a packet adapted to hold a volume of material, the packet disposed in the internal chamber of the cartridge.

3. The dispenser of claim 1 wherein the cartridge is made of plastic.

4. The dispenser of claim 3 wherein the cartridge is transparent.

5. A caulk dispensing system comprising the dispenser of claim 2 and further comprising a caulk gun comprising:
a cartridge receptacle adapted to support the dispenser;
a piston rod positioned to engage the plunger of the dispenser; and
a trigger adapted to advance the piston rod.

6. The system of claim 5 wherein operation of the trigger advances the plunger within the internal chamber of the cartridge; and
wherein advancement of the plunger causes the material in the packet to be expelled from the packet and through the nozzle.

7. The dispenser of claim 1 wherein the plunger further comprises:
a first base disposed at the first end of the outer wall; and
a second base disposed at the second end of the outer wall;
wherein the first base is parallel to the second base.

8. The dispenser of claim 7 wherein the outer wall is perpendicular to the first base and the second base.

9. The dispenser of claim 1 wherein the center plate defines an air flow port at a center of the center plate, the air flow port connecting the first planar side and the second planar side.

10. A reusable and reversible caulk dispenser comprising:
a tubular cartridge defining an internal chamber, the cartridge comprising an open first end and an open second end;
a cylindrical plunger disposed within the internal chamber and concentric with the cartridge; and
an end cap comprising:
a circular planar cap face having a top side and a bottom side, the cap face defining a discharge port at a center of the cap face;
an outer ring extending from the bottom side of the cap face, the outer ring being cylindrical and concentric with the cap face;
an inner ring extending from the bottom side of the cap face, the inner ring being cylindrical and concentric with the cap face; and
a nozzle extending from the top side of the cap face, the nozzle being cylindrical in nature and defining a flow path through the port of the cap face;
wherein the outer ring is disposed proximate a perimeter of the cap face and the inner ring is disposed proximate a perimeter of the discharge port of the cap face; and
wherein the end cap is adapted to be removably attached to the first end or the second end of the cartridge.

11. The dispenser of claim 10 further comprising a packet adapted to hold a volume of material, the packet disposed in the internal chamber of the cartridge;
wherein the packet has a first open end positioned proximate the nozzle; and
wherein the packet has a second end positioned adjacent the plunger; and
wherein pressure on the plunger causes material in the packet to be expelled from the packet and through the nozzle.

12. The dispenser of claim 11 wherein the nozzle comprises a threaded outer surface;
and wherein the dispenser further comprises a nozzle attachment threaded to the outer surface of the nozzle.

13. The dispenser of claim 10 wherein the tubular cartridge has an inner diameter; and
wherein the outer ring has an outer diameter that approximates the inner diameter of the cartridge;
such that the end cap may be inserted into the first end or the second end of the cartridge.

14. A caulk dispensing system comprising the dispenser of claim 11 and further comprising a caulk gun comprising:
a cartridge receptacle adapted to support the dispenser;
a piston rod positioned to engage the plunger of the dispenser; and
a trigger adapted to advance the piston rod.

15. The system of claim 14 wherein operation of the trigger advances the plunger within the internal chamber of the cartridge; and
wherein advancement of the plunger causes the material in the packet to be expelled from the open end of the packet and through the nozzle.

16. A method for using a caulk dispensing system, the method comprising:
inserting a packet of material in a tubular cartridge of a reusable caulk dispenser,
the cartridge having an open first end and an open second end;
such that a closed end of the packet is adjacent a plunger disposed in the cartridge; and
such that an open end of the packet is proximate the first end of the cartridge;
attaching an end cap comprising a nozzle to the first end of the cartridge;
placing the caulk dispenser in a caulk gun;
operating the caulk gun to advance the plunger in the cartridge and thereby expel material from the packet in the caulk dispenser through the nozzle of the end cap;
such that the packet is compressed around an inner ring of the end cap;
removing the caulk dispenser from the caulk gun;
removing the end cap from the first end of the caulk dispenser;
removing the packet of material from around the inner ring of the end cap of the caulk dispenser;
inserting a new packet of material in the second end of the cartridge of the caulk dispenser;
such that a closed end of the new packet is adjacent the plunger; and
such that an open end of the new packet is proximate the second end of the cartridge;
attaching the end cap to the second end of the cartridge; and
placing the caulk dispenser in the caulk gun.

17. The method of claim 16 wherein the material in the packet comprises a sealant.
